(19) United States
(12) Patent Application Publication
(10) Pub. No.: US 2010/0119914 A1
(43) Pub. Date: May 13, 2010

(54) Electrochemical Device Comprising One or More Fuel Cells

(76) Inventor: Arthur Koschany, Salzweg (DE)

Correspondence Address: PETER E. ROSDEN, 1505 LONDON ROAD, CHARLOTTESVILLE, VA, 22901-8881, US

(21) Appl. No.: 12/595,638

(22) PCT Filed: Apr. 17, 2008
(86) PCT No.: PCT/CN08/00783

§ 371 Date: Oct. 13, 2009

(30) Foreign Application Priority Data
Apr. 17, 2007 (CN) 200710039532.6

(51) Int. Cl. H01M 2/00

(52) U.S. Cl. 429/34

(57) ABSTRACT

An electrochemical device comprising one or multiple self-humidifying electrochemical fuel cells, wherein each electrochemical fuel cell comprises a main surface (9) which can be used for an electrochemical reaction and can consume the oxygen contained in the air. A single air flow enters into the fuel cell and is divided into at least two parts of air flow inside the fuel cell. At least one of these parts of air flow has mass transfer contact with the main surface (9). Otherwise, at least another part of air flow has no mass transfer contact with the main surface (9). The air flow is divided by a separation sheet (5).

### TECHNICAL FIELD

The present invention relates to the electrochemical and chemical fields, and more particularly to an electrochemical device comprising one or multiple fuel cells.

### BACKGROUND OF THE INVENTION

The fuel cell uses hydrogen as its fuel and oxygen as oxide. The hydrogen and oxygen react with each other to generate electricity and water without combustion. They are environmentally friendly, have high energy density, and are an efficient, reliable electricity generator for various applications in submarine, vehicle, laptop and mobile phone applications especially as a result of improving fuel cell technologies.

When the fuel cell is working, the oxygen electrode will generate water. Due to the migration of the electroosmosis, the hydrogen electrode is short of water, which could cause the fuel cell to work improperly. So, in order to maintain the fuel cell working in a stable and proper way, it is necessary to keep the water in the fuel cell in balance. In order to obtain humidification, which is an effective way to maintain the water in balance, currently people use a humidifying system, but this system can make the fuel cell system complicated and the cost high. Currently, there are three main types of self-moisturizing technologies for a fuel cell. The first one is to make water in the proton exchange membrane through a catalyzing reaction, but this process has the disadvantages of having large internal resistance and the possibility that a water shortage develops due to the absence of a matching water supply. The second is to improve the fuel cell structure itself so as to reach the self-moisturizing goal. Although this goal can be realized commercially, it will complicate the fuel cell structure and is not convenient in mass production. The third one is to increase the speed with which the water generated in the oxygen electrode to diffuse to the hydrogen electrode, but this process requires a high water concentration gradient or large diffusion co-efficient.

Current there are mainly two types of fuel cell structure: cathode open style fuel cell and cathode close style fuel cell.

The cathode open style fuel cell, namely single air fuel cell, can make the air with a stoich of ten times, even hundreds of times, flow through the cathode flow field plate to provide the fuel cell with oxygen, at the same time taking away the heat generated. Its technological characteristic is that most of, even all of the air flow has mass transfer contact with the fuel cell cathode. Some advantages are that the fuel cell stack structure is simple as is the periphery, control system and it is accompanied by low cost, small size and light weight. Some disadvantages are that the air flow with a large stoich takes away too much water while eliminating heat. Although these disadvantages can be overcome to some extent by increasing the cathode diffusion layer density and hydrophilicity, the results are not good with the side effect of sacrificing the output current density.

In a cathode closed style fuel cell, namely double air fuel cell, the air flow or cooling liquid flow for eliminating heat is completely separated from the air flow for oxygen supply, which is driven respectively by two blowers or pumps through two independent pipelines. Due to the oxygen supply air flow with a stoich of between 3 and 5, but normally not more than 10, there are no problems with too much water being taken away. Some disadvantages are that the fuel cell stack structure becomes complicated as does the periphery, control system and that it is accompanied by high cost, big size and heavy weight.

In the current technologies, there is an electrolyzer making oxygen by electrolyzing water. While it is working, water in the anode is electrolyzed into oxygen and protons. The protons move to the cathode through the electrolyte membrane to react directly with the oxygen in the air or to transform to hydrogen to react for generating water. Due to migration during electroosmosis, some water will be taken away. This water will be discharged in the way of gas or liquid through the cathode, which will cause the device to consume more water. So both the cathode open style structure and the cathode close style structure have the same problems as the fuel cell mentioned above.

### SUMMARY OF THE INVENTION

In order to overcome the disadvantages of the aforementioned cathode open style which can lose water easily and in the aforementioned cathode closed style whose structure is complicated by high cost with big size and heavy weight, the present invention proposed the following technical schemes:

A self-moisturizing electrochemical device, comprising one or more electrochemical cells, wherein each electrochemical cell comprises a main surface for electrochemical reaction capable of consuming oxygen in the air, wherein only one air flow enters into the said device. The air flow is divided into at least two partial air flows in the device without increasing the total pressure. At least one of the partial air flows is in mass transfer contact with the main surface, while at least one of the other partial air flows is not in mass transfer contact with the main surface; wherein the said air flow is separated by a separation sheet.

In order to get worthwhile results, the ratio of the cross sectional area of all the air flow(s) which is/are in mass transfer contact with the main surface to the cross sectional area of all the air flow(s) that is/are not in mass transfer contact with the main surface is smaller than 7:3. Otherwise there is no worthwhile difference from the traditional cathode open style structure.

Under perfect conditions, the separation of the said air flows does not increase the total pressure.

Under perfect conditions, at least two partial air flows will re-combine in the device due to distance from the outlet of the fuel cell to the outlet of the device.

The preferred design is that the separation sheet comprises a graphite plate or a metal folded plate with grooves thereon.

The cross sectional area of above mentioned groove may be trapezoidal, rectangular, in the shape of “ [symbol] ”, a cross, an irregular form or a combination of various forms.

In order to increase its life time, the surface of the metal folded plate may be coated with a protective layer.

The ratio of the cross section area of the air flow channel which is in mass transfer contact with the main surface of the electrochemical reaction to the air flow channel which is not in mass transfer contact with the main surface of the electrochemical reaction may be different at different regions in the same electrochemical cell. Because the working conditions in the different regions in the same electrochemical cell may be different, different humidifying levels may be required.

The area of the said separation sheet which is in contact with main surface is, preferably, 25%-75% of the area of the main surface. The contact area can only discharge moisture through diffusion in a properly oriented gas diffusion layer. So the bigger the contacting area is, the better the humidifying effect will be.

The inclination angle between the flank of the separation sheet (5) at the side of the partial air flow which is in mass transfer contact with the main surface and the main surface is either more than 95 degrees but less than 150 degree or less than 85 degree but more than 30 degree. If the areas of the two air flow cross sections are fixed, the angle can be changed so as to alter the contact area which helps to adjust the humidifying level without changing the stoich. However, changing the ratio of the cross section area of the two air flows for adjusting the humidifying level will not avoid changing the stoich.

Such a change could influence the performance of the device and make its design more complicated.

In order to commercialize the device, one or more electrochemical cells may be piled.

Each cell has a gas-proof barrier sheet (3) opposite the main surface (9), such that the barrier sheet confines at least one of the air flows not in mass transfer contact with the main surface (9) of the adjacent cell.

Compared with the prior art, the present invention has advantages of both an open cathode structure and a closed cathode structure, and produces better self-moisturizing effects at lower cost with reduced volume and weight.

### BRIEF DESCRIPTION OF THE DRAWINGS

FIG. 1 is a cross section drawing of the fuel cell and its adjacent separation sheet in the electrochemical device.

FIG. 2 is also a cross section drawing of the fuel cell and its adjacent separation sheet in the electrochemical device.

FIG. 3 is a cross section drawing of the electrolyzer and its adjacent separation sheet in the electrochemical device.

### DETAILED DESCRIPTION OF THE INVENTION

For purposes of this disclosure, the following definitions apply:

Mass transfer contact refers to contact between surfaces that can have matter and mass exchange which differs from contact between surfaces which transfer heat, vibration, current, etc.

The device described includes all the parts, accessories except the air source that generate air flows.

The stack is a generalized stack and may include only one electrochemistry cell comprising piled structure with end plates at both sides.

The electrochemical reaction main surface is wider than that of the electrode surface commonly referred to in the art. It may include the gas diffusion layer connected to the electrode.

The elements numbered in the drawings correspond to the following descriptions:
10. Groove area of all the air flow(s) that is/are not in mass transfer contact with the main surface
11. Groove area of all the air flow(s) that is/are in mass transfer contact with the main surface
12. Gas proof barrier sheet (for gas isolation and conducting purposes; one part of the electrochemical cell; the barrier sheet confining at least one of the air flows not in mass transfer contact with the main surface (9) of the adjacent cell.)
13. MEA (membrane electrode assembly)
14. Separation sheet
15. Gas diffusion layer on the main surface
16. Area of the main surface in contact with the separation sheet
17. The gas diffusion layer on the other side
18. Electrochemical reaction main surface

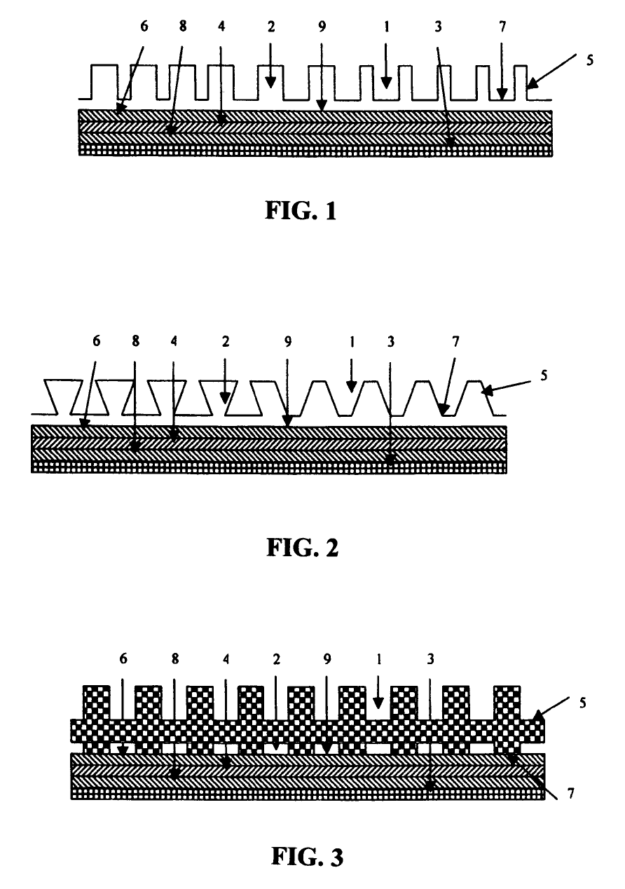

In addition, separation sheet 5 is in contact with the main surface of the electrochemical reaction main surface 9, but it is separated therefrom in FIG. 1 and FIG. 2 in order to see it clearly.

### Sample 1

FIG. 1 shows a single fuel cell in the fuel cell stack in the electrochemical device and adjacent separation sheet 5. Separation sheet 5 is a silver coated metal folded plate with the shape of “ [symbol] ”. Separation sheet 5 is arranged in interleaving fashion with air flow groove 1 that has no mass transfer contact with electrochemical reaction main surface 9 and air flow groove 2 that does have mass transfer contact with electrochemical reaction main surface 9. The separation angle between the flank of the channel of the partial air flow which is in mass transfer contact with the main surface 9 of the electrochemical reaction and the said main surface is 90 degrees, basically it is vertical. The air flow is separated by separation sheet 5 into two grooves to provide the oxygen the fuel cell needs while taking away the water generated at the oxygen side. After the air flow moves out of the fuel cell stack, but while it still remains in the electrochemical device, it re-combines and finally discharges from the electrochemical device. The separation of the said air flows does not increase the total pressure.

The ratio of the cross section area of the two air flow channels is different in the different regions in the fuel cell. On the right side of FIG. 1, due to the dry fuel, the proportion of the cross section area close to the fuel inlet is 1:2, which results in relatively high humidifying effects. On the left side of FIG. 1, due to the moisture taken by the fuel flow, the proportion of the cross section area close to the fuel outlet is 2:1, which results in relatively low humidifying effects. In the middle of FIG. 1, the proportion of the cross section area is 1:1, which results in middle level humidifying effects. So the average cross section area ratio is 1:1 by averaging the different conditions in the said regions.

The flank is vertical with the separation angle of 90 degrees. Thus, the ratio of the area which is in contact with the middle layer to the total area of electrochemical reaction main surface in the aforementioned three places is 67%, 33% and 50%, respectively, with the average being around 50%.

Compared to a fuel cell using traditional open cathode structure, after testing the stack of the present invention, the water equilibrium temperature is 60 degrees under the output current density of 0.5 A/cm2, which is 3 degrees higher than with the traditional open cathode structure.

### Sample 2

FIG. 2 shows the single fuel cell in the fuel cell stack in the electrochemical device and adjacent separation sheet 5. Separation sheet 5 is a silver coated metal folded plate with a special shape. Separation sheet 5 is arranged in interleaving fashion with air flow groove 1 that has no mass transfer contact with electrochemical reaction main surface 9 and air flow groove 2 that does have mass transfer contact with electrochemical reaction main surface 9. Air flow separately goes into the two grooves to provide the oxygen the fuel cell needs while taking away the water generated at the oxygen side.

Although the ratio of the cross section area of the two air flow channels remains 1:1 with no change in the different regions in the fuel cell, the proportion of the area of section 7 that is in contact with separation sheet 5 in electrochemical reaction main surface 9 in the left high region is 75%, while it is 25% in the right low region. This will result in the flank of groove 2 of the air flow which does have mass transfer contact with reaction main surface 9 having a non-vertical relationship with the reaction main surface. Its separate angle is 115 degree in the left high region and 65 degrees in the right low region. The reason for this different relationship is the same as for sample 1, which is to meet different humidifying requirement.

Compared to a fuel cell using traditional open cathode structure, after testing the stack of the present invention, the water equilibrium temperature is 60 degrees under the output current density of 0.5 A/cm2, which is 3 degrees higher than with the traditional open cathode structure.

### Sample 3

FIG. 3 shows the single cell and its adjacent separation sheet 5 in the electrolyzer stack in the electrochemical oxygen generator. Separation sheet 5 is a graphite plate with the shape of a cross. Air flow groove 2, which does have mass transfer contact with reaction main surface 9 and air flow groove 1 which has no mass transfer contact with reaction main surface 9 are located at the two sides of separation sheet 5 with the proportion of the cross section area of the air flow channel of around 1:3. Air flow groove 2 which does have mass transfer contact with reaction main surface 9 is vertical to the reaction main surface 9 with a separation angle of 90 degrees. The proportion of the area of section 7 which is in contact with separation sheet 5 in the electrochemical reaction main surface 9 is around 50%. The air flow separately goes into the two grooves to provide enough oxygen with the electrolyzer in order to directly react with the protons, reduce the electrochemical voltage and meanwhile take away the heat generated.

After testing, the electrochemical oxygen generator in this sample consumes 3 g of water every minute, which is 70% of the consumption of a comparable device using the open cathode style as its background technology.

1. An electrochemical device, comprising one or more self-moisturizing electrochemical fuel cells, wherein each electrochemical cell comprises a main surface (9) for electrochemical reaction capable of consuming oxygen from the air and wherein further only one air flow enters into the cell, said air flow being divided into at least two partial air flows in the cell, at least one of the partial air flows being in mass transfer contact with the main surface (9), while at least one of the other partial air flows is not in mass transfer contact with the main surface (9), wherein the air flows are separated by a separation sheet (5).

2. An electrochemical device according to claim 1 characterized in that the ratio of the cross sectional area (2) of all the air flow(s) which is/are in mass transfer contact with the main surface (9) to the cross sectional area (1) of all the air flow(s) that is/are not in mass transfer contact with the main surface (9) is smaller than 7:3.

3. An electrochemical device according to claim 2 characterized in that the air flow is divided without increasing the total pressure.

4. An electrochemical device according to claim 3 characterized in that at least two partial air flows are re-combined in the device.

5. An electrochemical device according to claim 4 characterized in that the separation sheet (5) consists of a graphite plate or a metal folded plate with grooves on.

6. An electrochemical device according to claim 5 characterized in that the cross sectional area of the above mentioned grooves includes trapezoids, rectangles, cross and irregular forms and the combination of various forms.

7. An electrochemical device according to claim 6 characterized in that the metal folded plate is coated with a protective layer.

8. An electrochemical device according to claim 7 characterized in that the ratio of the cross section area (2) of the air flow which is in mass transfer contact with the main surface (9) to the cross sectional area (1) of the air flow which is not in mass transfer contact with the main surface (9) is different in different regions in the same electrochemical cell.

9. An electrochemical device according to claim 8 characterized in that the area of the parts (7) of the separation sheet (5) which are in contact with the main surface (9) is 25% to 75% of the area of the main surface.

10. An electrochemical device according to claim 9 characterized in that the inclination angle between the flank of the separation sheet (5) at the side of the partial air flow which is in mass transfer contact with the main surface (9), and the main surface (9) is either more than 95 degrees but less than 150 degrees or less than 85 degrees but more than 30 degrees.

11. An electrochemical device according to claim 10 characterized in that one or more of said electrochemical cells are piled.

12. An electrochemical device according to claim 11 characterized in that each cell has a gas-proof barrier sheet (3) opposite the main surface (9), the barrier sheet confining at least one of the air flows not in mass transfer contact with the main surface (9) of the adjacent cell.

13. An electrochemical device, comprising one or more self-moisturizing electrochemical fuel cells, wherein each electrochemical cell comprises a main surface (9) for electrochemical reaction capable of consuming oxygen from the air and wherein further only one air flow enters into the cell, said air flow being divided into at least two partial air flows in the cell, at least one of the partial air flows being in mass transfer contact with the main surface (9), while at least one of the other partial air flows is not in mass transfer contact with the main surface (9), wherein the air flows are separated by a separation sheet (5) and wherein further ratio of the cross section area (2) of the air flow which is in mass transfer contact with the main surface (9) to the cross sectional area (1) of the air flow which is not in mass transfer contact with the main surface (9) is different in different regions in the same electrochemical cell.

14. An electrochemical device, comprising one or more self-moisturizing electrochemical fuel cells, wherein each electrochemical cell comprises a main surface (9) for electrochemical reaction capable of consuming oxygen from the air and wherein further only one air flow enters into the cell, said air flow being divided into at least two partial air flows in the cell without increasing the total pressure in the cell, at least one of the partial air flows being in mass transfer contact with the main surface (9), while at least one of the other partial air flows is not in mass transfer contact with the main surface (9), wherein the air flows are separated by a separation sheet (5) and wherein further ratio of the cross section area (2) of the air flow which is in mass transfer contact with the main surface (9) to the cross sectional area (1) of the air flow which is not in mass transfer contact with the main surface (9) is different in different regions in the same electrochemical cell.
